(19) United States
(12) Patent Application Publication
(10) Pub. No.: US 2007/0042323 A1
(43) Pub. Date: Feb. 22, 2007

(54) Grinder guard

(76) Inventor: Michael J. Florman, Santa Monica, CA (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/507,966

(22) Filed: Aug. 22, 2006

Related U.S. Application Data
(60) Provisional application No. 60/710,232, filed on Aug. 22, 2005.

(51) Int. Cl. A61C 1/16

(52) U.S. Cl. 433/116

(57) ABSTRACT

A dental working element guard may include grip enhancements such as finger plates or cups. Embodiments can accommodate contra-angles. Guards made of transparent plastic improve work area visibility for a dentist or user. Some embodiments are made of plastic and are disposable. Embodiments may include a lubrication port for introducing a lubricant. The port may include an orifice in a wall of the guard. The port may also include a tube, for guiding the placement of a lubricating hypodermic needle and/or a hose barb for communication with a lubrication source via tubing. The guard may be used in conjunction with known working elements such as grinding disks or in conjunction with an improved grinding disk having a pilot region or ring that does not include abrasive material and aids in positioning the disk between teeth. A disk stop can position a disk for receiving lubricant.

This application claims the benefit of U.S. Provisional Application No. 60/710,232, filed Aug. 22, 2005, which is incorporated herein by reference in its entirety.

### CROSS REFERENCE

This application is related to seven other applications by the same inventor filed contemporaneously herewith. Six of the applications are titled GRINDER GUARD, and one application is titled GRINDER DISK. All of these applications are included herein by reference.

### BACKGROUND

Embodiments disclosed herein are related to the art of dentistry. More particularly, embodiments are related to guards for dental grinding tools or other working elements. Moreover, some embodiments are related to disposable guards for dental working elements. However, some embodiments may be sterilized and reused.

In the practice of dentistry, it is sometimes necessary to clean, polish, drill and/or grind the teeth of a patient. Various tools and components are available that aid in performing these procedures. For example, U.S. Pat. No. 583,735 to C. W. Dodge describes a dental polishing disk. U.S. Pat. No. 503,258 to R. G. Stanbrough discloses a dental disk and carrier.

U.S. Pat. No. 689,596 to Platt; U.S. Pat. No. 1,535,187 to Terry; and U.S. Pat. No. 2,448,758 to Angell disclose dental hand pieces which receive and drive grinding, polishing or drilling elements.

U.S. Pat. No. 925,379 to Reed, et al.; U.S. Pat. No. 1,042,039 to Schlund; U.S. Pat. No. 1,534,817 to Thiedemann, et al.; U.S. Pat. No. 1,548,180 to Brown, et al.; U.S. Pat. No. 1,621,190 to Brown; U.S. Pat. No. 1,678,096 to Andresen; U.S. Pat. No. 1,999,488 to Swisher, et al.; U.S. Pat. No. 2,504,233 to Staunt; U.S. Pat. No. 2,568,315 to Björklund; U.S. Pat. No. 2,591,772 to Bjöbrklund; U.S. Pat. No. 2,879,595 to Uhler, et al.; U.S. Pat. No. 2,928,174 to White; U.S. Pat. No. 2,945,299 to Fritz; U.S. Pat. No. 3,014,278 to Aymar, et al.; U.S. Pat. No. 3,509,629 to Kidokoro, et al.; U.S. Pat. No. 3,521,358 to Berman; U.S. Pat. No. 3,629,944 to Avakoff, et al., and U.S. Pat. No. 5,915,966 to Miller describe dental hand pieces or driving mechanisms that include contra-angles or tool receiving and driving heads that are disposed at an angle to a longitudinal axis of the dental hand piece.

U.S. Pat. No. 159,048 to Starr; U.S. Pat. No. 399,350 to Sisson; U.S. Pat. No. 525,278 to Peck; U.S. Pat. No. 635,244 to Gholson; U.S. Pat. No. 696,155 to Williams; U.S. Pat. No. 763,918 to Magoon; U.S. Pat. No. 787,981 to Green; U.S. Pat. No. 823,167 to Green; U.S. Pat. No. 973,894 to Toomey; U.S. Pat. No. 994,829 to Fell; U.S. Pat. No. 1,004,118 to Waters; U.S. Pat. No. 1,021,065 to Neil, Jr.; U.S. Pat. No. 1,067,571 to Abbott; U.S. Pat. No. 1,101,947 to Morgan; U.S. Pat. No. 1,117,660 to Gilmore; U.S. Pat. No. 1,152,122 to Samphere; U.S. Pat. No. 1,285,273 to Luzzi; U.S. Pat. No. 1,390,354 to Fried; U.S. Pat. No. 1,841,915 to Reiter; U.S. Pat. No. 2,307,677 to Hawkinson; U.S. Pat. No. 2,731,722 to Wilen; illustrate guards, shields, holders and the like for protecting the patient and dentist from abrasive or cutting edges of spinning polishing, grinding and drilling elements.

U.S. Pat. No. 1,943,668 to Hartman discloses a guide attachment for a contra-angle.

All of these references are incorporated herein by reference for all that they disclose.

Attachments, such as the guards, shields, holders and guides described in the references mentioned above, must be sterilized before they can be used in a procedure on a patient. For example, the guards, shields, holders or attachments are processed through an autoclave. This requires that the attachments be made of material that can survive the autoclaving process. For example, such attachments are often made of stainless steel. Stainless steel attachments are relatively expensive. Additionally, the cleaning and sterilization process is time consuming and prone to error.

Therefore, there has been a desire for inexpensive and/or disposable shields, guards or attachments for dental instruments. Additionally, there has been a desire for guards, shields or attachments that are compatible with or can be used in conjunction with contra-angles or dental hand pieces including contra-angles or contra-angle attachments.

### BRIEF DESCRIPTION OF THE DRAWINGS

FIG. 1 is a perspective view of an illustrative guard for a dental working element.

FIG. 2 is a perspective view of an illustrative guard including finger plates.

FIG. 3 is a perspective view of an illustrative guard including finger cups.

FIG. 4 and FIG. 5 are schematic views of illustrative guards adapted for use with contra-angles.

FIG. 7 is a perspective view of an illustrative guard including an illustrative lubrication port and an illustrative disk stop protrusion.

FIG. 6, FIG. 8 and FIG. 9 are schematic views of illustrative guards installed or being installed on dental drive elements or hand tools.

FIG. 10 is a perspective view of a grinding disk that includes a safety or pilot region.

### DETAILED DESCRIPTION

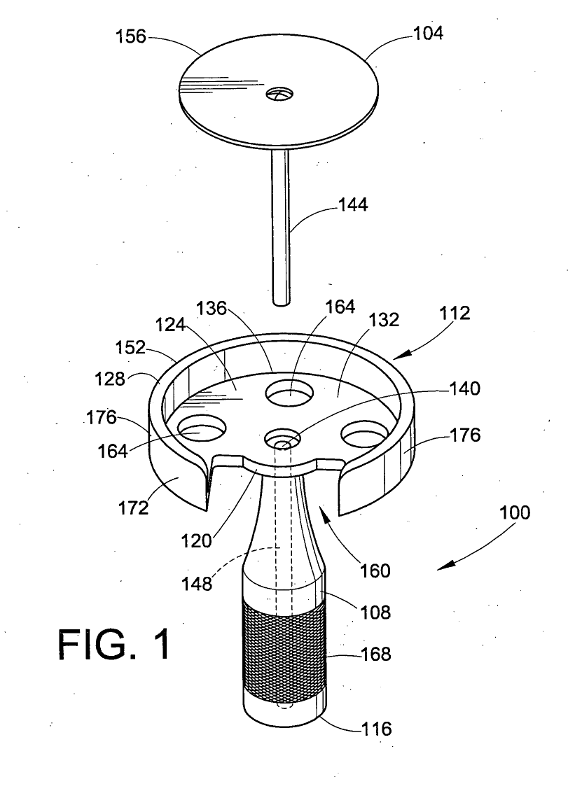

Referring to FIG. 1, an attachment or guard 100 for an associated dental working element (e.g., 104) includes a shaft portion 108 and a guard portion 112. The shaft portion 108 can include a mating end 116 and a guard end 120. The mating end 116 can include an attachment mechanism. For instance, the attachment mechanism is adapted to attach to a dental drive element or hand tool. The guard end 120 carries the guard portion 112. The guard portion 112 includes a plate portion 124 and a wall portion 128 extending above a surface 132 of the plate portion 124 and is disposed adjacent to a peripheral edge (e.g., 136) of at least a portion of the plate portion 124. The plate portion includes a plate passage 140 for receiving a working element drive shaft (e.g., 144) or mandrel. The shaft 108 may include a shaft passage (e.g., 148). If the shaft 108 includes a shaft passage (e.g., 148), the shaft passage and the plate passage are axially aligned for cooperatively receiving the associated drive shaft (e.g., 144) of the associated working element 104.

For example, the working element 104 can be a grinding disk such as a diamond coated grinding disk for grinding and shaping teeth of a dental patient. Alternatively, the working element may be a drill bit or a polishing wheel or disk.

The guard portion 112 is shaped to guard or protect the fingers and hands of a dentist using the working element and to protect portions of the mouth of the patient that are not intended to be acted on by the working element (e.g., 104). For example, the guard portion 112 is shaped to protect the lips, cheeks, tongue and other mouth portions from the spinning working element (e.g., 104) while still allowing the working element (e.g., 104) to be applied to the intended portion of the mouth (e.g., a particular tooth).

In the illustrated embodiment of FIG. 1, the working element 104 is a grinding disk. The plate portion 124 is generally disk shaped and has a diameter that is a bit larger than a diameter of the grinding disk.

The wall 128 extends around a portion of the perimeter 136 of the generally disk-shaped plate portion 124 and is spaced away from a peripheral edge of the associated disk 104 when the disk is installed in the guard 100. The wall 128 has a height that is higher than a thickness of the disk 104. When the disk 104 is installed in the guard 100, the disk 104 is below a top edge 152 of the wall 128. Therefore, the fingers of the dentist and the tongue, cheeks and lips of the patient are prevented from approaching portions of an edge 156 of the disk 104 guarded by the wall 128.

While the wall 128 has a generally circular cross section and the plate 124 is generally circular, there is at least one gap or access point 160 provided in both the wall 128 and plate 124. For instance, the gap 160 provides an exposure for a portion of the working element or disk 104. The exposed portion of the working element 104 can be applied to the target portion of the patient's mouth. For example, the portion of the disk 104 exposed by the gap 160 can be applied to a tooth or between two teeth in order to grind, shape a tooth or enlarge or create a space between two teeth.

Additional voids may be provided in the guard portion 112. For example, debris exit apertures 164 may be included in the plate portion 124, as an aid to preventing the buildup of bone, tooth structure and fluid behind or around the working element 104. Additionally, or alternatively, apertures or slits may be provided in the wall 128 for similar purposes. Preferably, the voids are sized large enough to prevent clogging, while at the same time being small enough to prevent contact between the fingers of the dentist, or the tongue or cheeks of the patient, and the working element 104.

As indicated above, the shaft 108 may include a shaft passage 148 for receiving the drive shaft 144 or mandrel of the working element 104. Alternatively, as will be discussed in greater detail below, the shaft may simply serve as a connecting or linking element between the guard portion 112 and the attachment mechanism (not shown).

The attachment mechanism (not shown) may be any known or later developed attachment mechanism. For example, the illustrated cylindrical shaft 108 may include threads for threading onto a driving head of a dental drive element or hand tool. Other embodiments may include a bayonet or snap-on mechanism. The shaft may include grip enhancing means such as a knurled portion 168 to help prevent slippage during guard attachment.

The guard portion 112 may also include group enhancing means. For example, an outer surface 172 of the wall 128 may include knurled portions 176 or rubber or rubber-like pads or pad (not shown). For instance, the dentist may hold the guard portion 112 between two fingers in order to guide and steady the work element 104, guard 100 and a drive element assembly during a dental procedure. Grip enhancing means such as the knurled portion 176 of the wall 128,or rubber pads, reduce the risk of the guard 100 slipping from the grasp of the dentist.

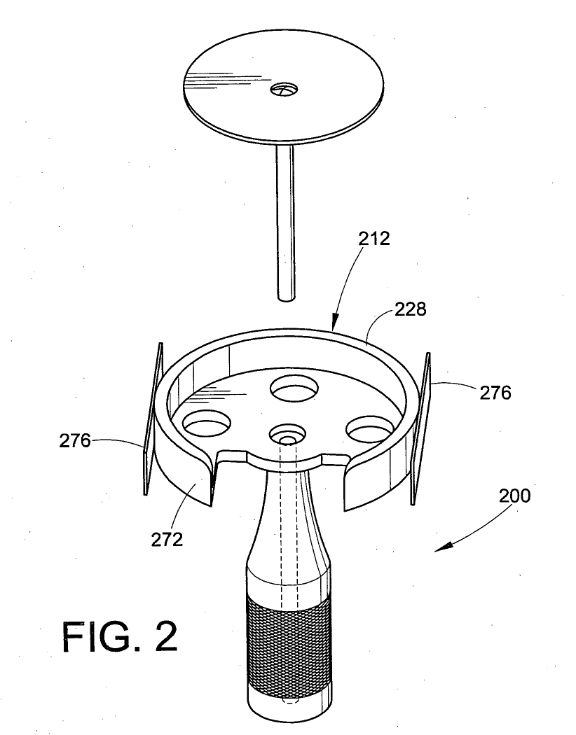

Other guard portion grip enhancing elements may be included. For example, referring to FIG. 2, a guard 200 includes a guard portion 212 having a wall portion 228 having an outer surface 272 that carries first and second finger plates 276. The first and second finger plates 276 are carried approximately tangentially on spaced portions of the outer surface 272. For example, the first and second finger plates 276 may be carried on opposite portions of the outer surface 272 of the wall portion 228. Alternatively, the first and second finger plates 276 are located at other convenient locations for aiding the dentist in grasping the guard 200.

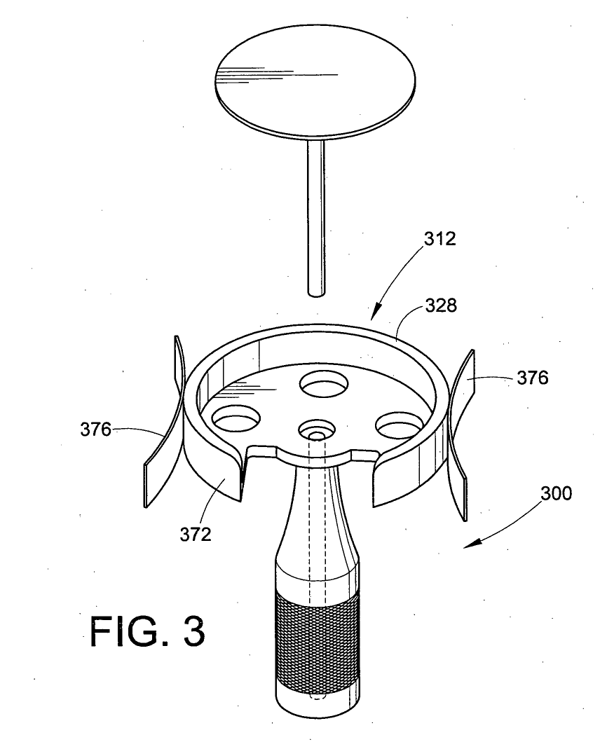

Referring to FIG. 3, a third illustrative guard 300 is similar to the second illustrative guard 200. However, instead of carrying finger plates 276, a guard portion 312 includes a wall portion 328 having an outer surface 372 that carries first and second finger cups 376. For example, the finger cups 376 are plates curved to approximate the contours of a thumb and forefinger of a dentist. Alternatively, the finger cups 376 may be in the form of more complete pockets approximating tip portions of fingers of a glove. As described with reference to the second illustrative guard 200 and the finger plates 276 associated therewith, the finger cups 376 may be carried on spaced portions of the outer surface 376 of the wall portion 328. For instance, the finger cups 376 may be carried on opposite portions of the outer surface 376 of the wall portion 328. Alternatively, the finger cups 376 may be located at some other location that is convenient and/or enhances the grip of the dentist on the guard 300 during a dental procedure. Finger plates and cups may include additional grip enhancements, such as knurls or rubber-like pads.

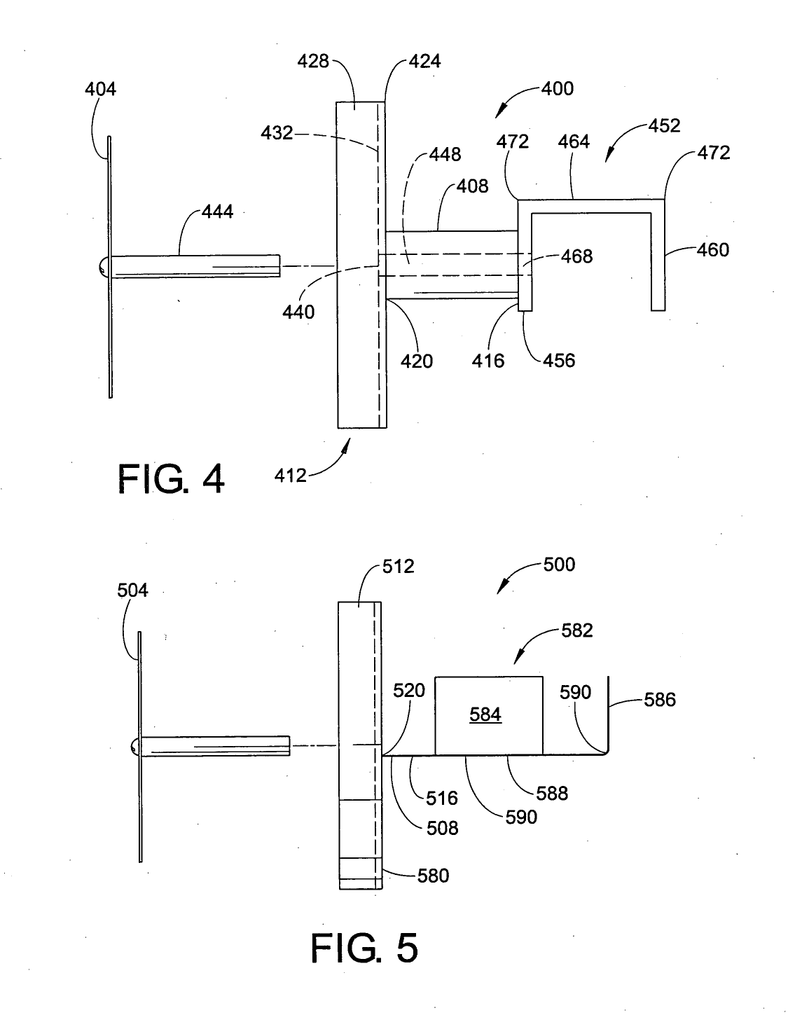

Referring to FIG. 4, a fourth illustrative guard 400 protects a patient and/or dentist from unnecessary exposure to abrasive or cutting portions of a working element (e.g., 404) and is adapted for use with a contra-angle. The fourth illustrative guard 400 includes a shaft portion 408 and a guard portion 412. The shaft portion 408 includes a mating end 416 and a guard end 420. The guard portion may be similar to any of the guard portions 112, 212, 312 described above. For example, the guard portion 412 includes a plate portion 424 and a wall portion 428. The wall portion 428 extends away from a surface 432 of the plate portion. The wall portion 428 is disposed adjacent to a peripheral edge (not shown) of at least a portion of the plate portion 424. The guard portion 412 includes a passage 440 for receiving an associated working element drive shaft or mandrel 444 of the associated working element (e.g., 404). The shaft 408 may also include a passage 448. If the shaft 408 includes a shaft passage 448, the guard passage 440 and the shaft passage 448 are axially aligned with each other for cooperatively receiving the drive shaft or mandrel 444 of the working element 404.

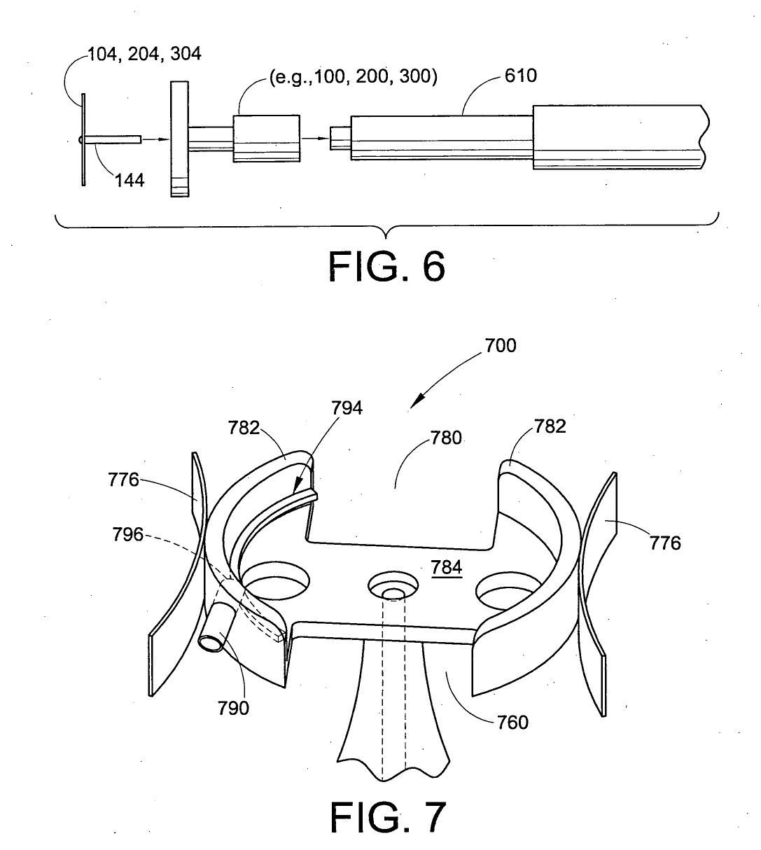

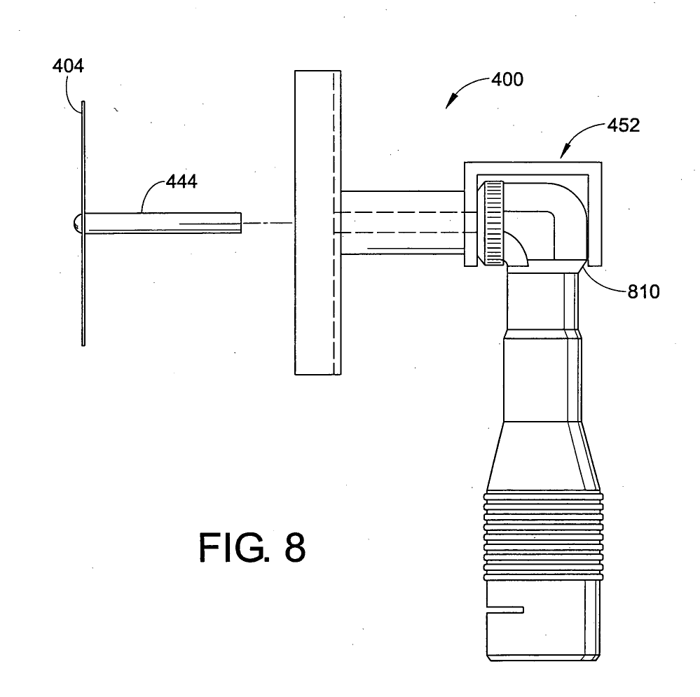

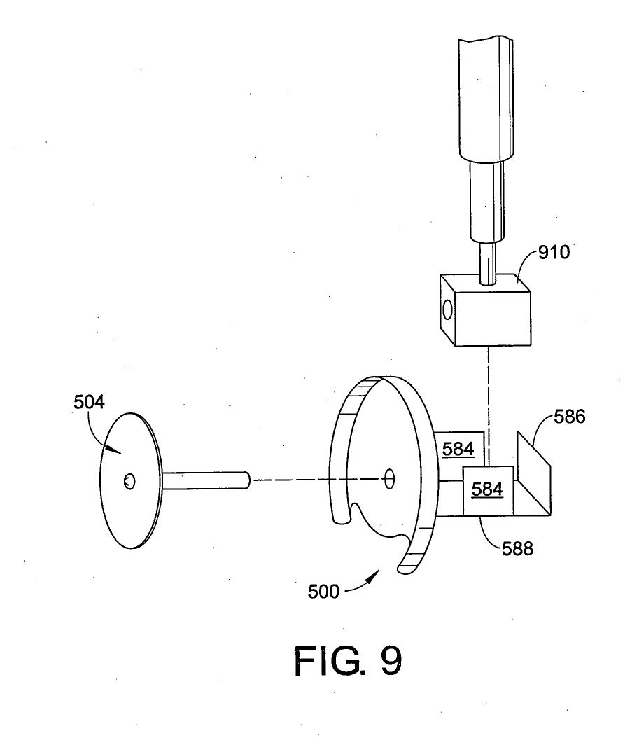

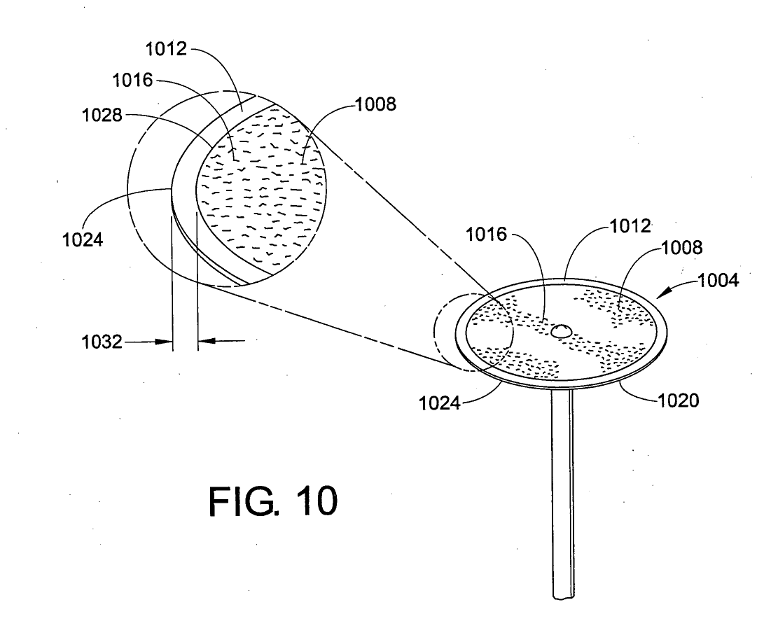

The fourth illustrative guard 400 includes an attachment mechanism 452 adapted to attach to a dental drive element or hand tool that includes a contra-angle. For instance, the attachment mechanism 452 is of such size, shape and material that it acts as a grasp, grip or snap-on mechanism for securing the guard 400 to the contra-angle of the dental drive mechanism or hand tool. For example, the attachment mechanism 452 includes a shaft wall 456 and a distal wall 460 and a linking arm or wall 464 therebetween. For instance, the linking arm or wall 464 and/or junctions 472, between the linking arm or wall 464 and one or both of the shaft wall 456 and the distal wall 460 may be resilient thereby allowing temporary displacement of the distal wall 460 and/or linking arm or wall 464 during a guard 400 attachment procedure. For instance, portions of the attachment mechanism 454 are deflected as the distal wall 460 is urged over wide or larger portions of the contra-angle and then return to a natural grasping or gripping position when the guard 400 is in a fully installed position with respect to the contra-angle. Alternatively, and/or additionally, the deflection may be temporary during an installation process and be relieved or partially relieved when the guard is fully installed and captured by mating contours of the attachment mechanism 452 and the contra-angle (see FIG. 7). Optionally, portions of the attachment mechanism 452 may include such depressions and protrusions (not shown) or contours as are required or desired to provide a custom fit to a particular model or type of contra-angle.

The shaft wall 456 abuts and may be contiguous with the mating end 416 of the shaft 408. The shaft wall 456 includes a passage 468 for receiving the drive shaft or mandrel 444 of the working element 404 and passing through to the contra-angle of the dental drive element or hand tool. If the shaft 408 includes a shaft passage 448, then the shaft wall passage 468 is axially aligned with the shaft passage 448.

Referring to FIG. 5, a fifth illustrative guard 500 for a working element 504 includes a shaft portion 508 and a guard portion 512. The guard portion 512 may be similar to any of the guard portions 112, 212, 312, 412 described above. The shaft portion 508 may be considered to include a mating end 516 and a guard end 520. However, the mating end and the guard end may be close together or even coincide. For instance, in some embodiments, a back surface 580 of a plate portion of the guard portion 512 may be intended to abut a portion of an associated dental drive element or hand tool when the guard (e.g., 500) is installed thereon. Therefore, the back surface 580 of the plate portion might be considered part of an attachment mechanism. Alternatively, the back surface 580 may be spaced from the dental drive element by a portion of the shaft portion 508.

As indicated above, in the fifth illustrative guard, an attachment mechanism 582 may include the rear surface 580 of the guard portion 512 or plate portion. Additionally, or alternatively, the attachment mechanism 582 may include side walls 584 (see also FIG. 8), a distal wall 586 and a linking arm or wall 588. The linking arm or wall 588 and/or junctions 590 between the linking arm or wall 588 and the side walls 584 and/or distal wall 586 may be resilient. In a manner similar to that described with reference to the fourth illustrative guard 400 and the attachment mechanism 452 thereof, the walls 584, 586 junctions 590 and/or the linking arm 588 of the attachment mechanism 582 of the fifth illustrative guard 500 may flex or be deflected about portions of a contra-angle. The flexure and resiliency of the attachment mechanism 582 portions 584, 586, 588 and/or 590 may provide a gripping force to secure the fifth illustrative guard 500 to the contra-angle. Alternatively, and/or additionally, the deflection may be temporary during an installation process and be relieved or partially relieved when the guard is fully installed and captured by mating contours of the attachment mechanism 582 and the contra-angle (see FIG. 8).

Referring to FIG. 6, some guards (e.g., 100, 200, 300) may attach, and include attachment mechanisms for attaching, to straight drive heads of dental drive elements or hand tools. The attachment mechanisms may include threads, bayonet mounts, snap-on mechanisms, and/or friction fits. Some guards may simply be held in place because they are captured by the working element (e.g., 104, 204, 304) when the drive shaft or mandrel (e.g., 144) is captured in a chuck or other working tool capture mechanism of the drive head (e.g., 610) of the dental hand tool or drive element.

Referring to FIG. 7, a sixth illustrative guard 700 can include any of the elements or features of the previously described guards (e.g., 100, 200, 300, 400, 500). For example, as illustrated, the sixth illustrative guard 700 includes a first gap or access point 760 and finger plates or cups 776 that are similar to those described in reference to, for example, FIGS. 1-3. Additionally, the sixth guard 700 includes a second gap or access point 780 at a second location in a guard wall 782 and guard plate 784. For example, the second gap 780 may be located opposite or displaced 180 degrees from the first gap 760. Alternatively, the second gap 780 may be positioned at other positions relative to the first gap 760. The second gap 780 may provide added flexibility for holding and positioning the dental tool while performing a dental procedure, thereby increasing the likelihood that a comfortable working position and/or tool orientation may be found. Aditionally, the second access point or gap 780 may allow a dentist to shape an upper tooth after first working on a lower tooth without repositioning and/or reorienting the dental tool during the dental procedure.

The sixth guard 700 also includes a lubrication well or port 790 and a disk stop protrusion, guide or shelf 794 adjacent thereto.

For instance, the lubrication port or well 790 is configured to receive a needle of a dental hypodermic. The hypodermic may be filled with a dental lubricant such as, for example, a fluoride gel, water or other natural lubricant. For example, the lubricant port takes the form of an orifice or tube through a portion of the wall portion (e.g., 782) of a guard (e.g., 700). For instance, the needle of the hypodermic is received through the lubrication port so that lubricant can be applied to a surface, such as a top surface of an outer edge of a work element, such as a grinding disk. Alternatively, the lubrication port may include a nipple or hose barb on or extending outwardly from an outer surface 795 of the wall portion (e.g., 782) for receiving a lubricant delivery tube whereby lubricant is delivered to a surface of the tool (e.g., 104, 204, 304, 404) by automatic and/or continuous delivery means or by a hand operated hypodermic connect to a remote end of the delivery tube.

The disk stop or protrusion 794 is located adjacent to, or in close proximity to, an inner portion (e.g., 796) of the lubrication port, tube or well 790. For instance, the disk stop protrudes from an inner surface (e.g., 798) of the wall portion 782 of the guard (e.g., 700) at an elevation on that wall surface 798 that positions the stop 794 behind the work element or disk (e.g., 104, 204, 304, 404) when the work element is installed within the guard (e.g., 700). For instance, when the work element is a disk (e.g., 104, 204, 304, 404), the work element may be relatively thin and flexible. Accordingly, the work element may tend to warp or flex so that it appears to wobble up and down as it is rotated or spun by the dental tool. The disk stop 794 may urge portions of the disk that are warped downward and away from the lubrication port back toward the lubrication port, thereby ensuring that all portions of the disk or dental tool are properly positioned to receive lubrication.

In FIG. 7, the disk or tool stop 794 is depicted as a continuous shelf protruding from the inner surface 798 of one portion of the wall portion 782. However, in some embodiments, the stop 794 protrudes from the inner surface 798 of the entire wall portion 782. Alternatively, the stop 794 is implemented as one or more discrete protrusions that extend from the inner surface 798 of the wall portion 782 at least in a region that is in close proximity to the inner portion 796 of the lubrication orifice, port or tube 790 in order to ensure that the disk or work element is close enough to the lubrication well 790 to draw away lubricant by capillary action or other similar means.

Any of the previously described guards (e.g., 100, 200, 300, 400, 500) can include one or more of the features (e.g., 780, 790, 794) described with particular reference to the sixth embodiment 700. Furthermore, any of the features described with reference to the first through fifth guards (e.g., 100, 200, 300, 400, 500) can be included guards such as that depicted in FIG. 7.

Referring to FIG. 8 and FIG. 9, some guards (e.g., 400, 500) include attachment mechanisms 452, 582 for attaching the guards (e.g., 400, 500) to contra-angles (e.g., 810, 910) of dental drive elements or hand tools. For instance, as explained above, portions of the attachment mechanisms 452, 582 may be resilient or flex when receiving or mating with an associated contra-angle (e.g., 810, 910). Such flexure may create a resilient force for gripping the associated contra-angle (e.g., 810, 910), which may stabilize the guard (e.g., 400, 500) during a working element (404, 504) and drive shaft or mandrel (e.g., 444) installation process, with the guard (e.g., 400, 500) being captured between the working element (e.g., 404, 504) and the contra-angle (e.g., 810, 910) when a drive shaft (e.g., 444) or mandrel of the working element (404, 504) is captured in the chuck or other shaft grasping mechanism of the contra-angle (e.g., 810, 910). Alternatively, the contra-angle grip or attachment mechanism (e.g., 452, 582) may secure the guard (e.g., 400, 500) to the contra-angle (e.g., 810, 910) independent of the installation of the working element (404, 504).

As indicated with respect to FIG. 1, FIG. 2 and FIG. 3, guard portions may include finger grips or grip enhancing means. For instance, the guard portions 412, 512 of the fourth 400 and fifth 500 guards may include knurled edges (e.g., 176), finger plates (e.g., 276) or finger cups (e.g., 376, 776) carried approximately tangentially on spaced portions of outer surfaces of the wall portions (e.g., 428) of the guards (e.g., 400, 500, 700).

Guards (e.g., 100, 200, 300, 400, 500, 700) may be unitary in construction. That is, the guards (100, 200, 300, 400, 500, 700) may be molded or machined from metal or plastic and formed as a single contiguous piece. Alternatively, individual components such as guards, shafts, attachment mechanisms, finger plates and/or finger grips may be manufactured separately and assembled together through attachment mechanisms such as, but not limited to, adhesives, bonding, welds, rivets, screws and bolts.

Preferably, the guards are made of plastic such as, for example, acrylonitrile-butadiene-styrenes (ABS), styrene-butadiene copolymers (SBC), acrylics, and polyproplyenes. The plastic might be selected to be an injection moldable plastic. The plastic might be selected to be sterilizable, at least one time, through known or as yet to be developed sterilization processes. Preferably, the plastic is inexpensive, thereby allowing the guard (e.g., 100, 200, 300, 400, 500, 700) to be properly disposed of after a single use. In some instances it might be desirable to select a plastic that has a melting point or glass transition temperature at or below standard autoclave chamber or cavity operating temperatures (e.g., below about 250° F. or 121° C.) and/or pressures. For example, it might be desirable to prevent unauthorized reuse through autoclaving by manufacturing the guard from a plastic that melts or softens so that the guard will deform if exposed to sterilizing temperature and/or pressures used in an autoclave. In other instances it may be desirable to select a plastic having a higher melting point or glass transition temperature, thereby allowing reuse through autoclaving. Polycarbonates and nylons that have such higher melting points/glass transition temperatures are available. The manufacture of the guard (e.g., 100, 200, 300, 400, 500, 700) from transparent plastic may allow a dentist to see more of a work area or target tooth than would be afforded by the use of other materials. Furthermore, a guard made from a transparent plastic can allow light from an illumination source, such as, for example, light delivered to the work area via a fiber optic cable, to pass through and better illuminate the work area. Indeed, at least some transparent plastics have indexes of refraction such that they act as optical fibers. A guard made of one of these plastics could conduct or guide light from a light source to the work area, through edges of the guard. Transparent ABSs, SBCs, acrylics, and polypropylenes, polycarbonates and nylons are available.

Referring to FIG. 10, an improved dental working element such as a grinding wheel or disk 1004 includes a grinding or work portion 1008 and a pilot or safety region 1012. The disk 1004 can have a diameter of about 0.5 cm to about 3 cm in diameter and has a thickness of about 0.2 mm to about 1.5 mm. For example, the pilot or safety region 1012 is an outer ring portion of the grinding disk 1004 that is devoid of abrasive material. The work or grinding portion 1008 carries an abrasive such as a diamond dust or grit impregnated adhesive. While a top surface 1016 of the disk 1004 is visible in FIG. 10, a bottom or under surface 1020 of the disk 1004 may be similarly configured with a working surface and safety or pilot region. Alternatively, the bottom or under surface 1020 may be completely devoid of grinding or cutting material. The disk 1004 includes a means (not shown) for attaching the disk to a shaft or mandrel. For example, the disk 1004 may include an opening or orifice that is centered on the disk. A portion of a fastener (not shown) such as screw, bolt, rivet or snap may be placed through the whole and screwed, bolted, riveted or snapped into the shaft or mandrel. Alternatively, the substrate may be unitary with an attachment means, such as a treaded element or snap. Furthermore, the disk may be unitary with the shaft or mandrel. In yet other embodiments the disk may be secured to the shaft or mandrel with an adhesive or weld (e.g. ultrasonic)

The pilot or safety area 1012 may be a ring extending from an outer edge 1024 radially inward to a work portion 1008 boundary 1028. For instance, the radial distance between the outer edge 1024 and the boundary 1028 may be from about 0.1 mm to about 2.0 mm. That is, the abrasive or aggregate including an abrasive material adhered to the disk shaped region of at least the first or top surface of the substrate. The disk shaped region is centered on the disk shaped substrate and has a diameter that is smaller than the radius of the disk shaped substrate by about 0.2 mm to about 4 mm. The pilot or safety region 1012 allows the user to, for example, guide the disk between teeth to be cut or ground with a reduced level of risk of damaging tooth structure that might otherwise be inadvertently cut while the user or dentist attempts to line up or properly position a disk in the tight space between two adjacent teeth.

A grinding disk, such as the grinding disk 1004, with a pilot or safety region (e.g., 1012) can be used in conjunction with any of the guards (e.g., 100, 200, 300, 400, 500, 700) described above.

It will be appreciated that various of the above-disclosed and other features and functions, or alternatives thereof, may be desirably combined into many other different guards or shields. Various alternatives, modifications, variations or improvements are intended to be encompassed by the following claims.

1. A guard for a dental working element, the guard comprising:
a unitary body made of transparent plastic including a shaft portion and a guard portion, the shaft portion including a mating end and a guard end, the mating end having an attachment mechanism adapted to attach to a dental drive element, the guard end carrying the guard portion, the guard portion including a plate portion and a wall portion extending above a surface of the plate portion and being disposed adjacent a peripheral edge of at least a portion of the plate portion, the guard portion including a passage for receiving a working element drive shaft or mandrel.

2. The guard of claim 1 wherein the unitary body is made of an injection moldable plastic.

3. The a guard of claim 1 wherein the unitary body is made of a plastic having a plastic or a glass transition temperature below about 250 ° F. or 121° C.

4. The a guard of claim 1 wherein the unitary body is made of a plastic having a plastic or a glass transition temperature above about 250° F. or 121° C.

5. The guard of claim 1 wherein the unitary body is made of at least one of an acrylonitrile-butadiene-styrene (ABS), a styrene-butadiene copolymer (SBC), an acrylic, and a polyproplyene.

6. The guard of claim 1 wherein the unitary body is made of at least one of a polycarbonate and a nylon.

7. The guard of claim 1 wherein the wall portion includes first and second finger grips.

8. The guard of claim 7 wherein the first and second finger grips comprise:
first and second finger plates carried approximately tangentially on spaced portions of an outer portion of the wall portion of the guard portion.

9. The guard of claim 7 wherein the first and second finger grips comprise:
first and second finger cups carried approximately tangentially on spaced portions of an outer portion of the wall portion of the guard portion.

10. The guard of claims 7 wherein the first and second finger grips include friction increasing means.

11. The guard of claim 1 wherein the unitary body further comprises:
a contra-angle grip, made of plastic and being adapted to receive and releasably grip a contra-angle of the dental drive element.

12. The guard of claim 1 further comprising:
a lubrication port providing communication through the wall portion for the delivery of a lubricant to a portion of the associated dental working element.

13. The guard of claim 12 wherein the lubrication port comprises at least one of:
an orifice in the wall portion, a tube extending through the wall portion and a hose barb or nipple extending outwardly from an outer surface of the wall portion.

14. The guard of claim 12 further comprising:
a disk stop protrusion extending away from an inner surface of at least part of the wall portion and located adjacent to the lubrication port, whereby at least a portion of the associated dental working element can be prevented from bending or warping, in at least one direction, away from a position where the working element can receive lubrication from the lubrication port.

15. The guard of claim 1 further comprising:
a disk stop protrusion extending away from an inner surface of at least part of the wall portion, whereby an outer edge of the associated dental working element can be prevented from bending or warping beyond a position of the disk stop protrusion.

16. The guard of claim 1 wherein the guard portion includes a first access point provided in both the wall portion and the plate portion, the first access point providing an exposure for a portion of the working element when the working element is installed in the guard.

17. The guard of claim 16 wherein the guard portion includes at least a second access point provided in both the wall portion and the plate portion in spaced relation to the first access point, the second access point providing a second exposure for a portion of the working element when the working element is installed in the guard.
